(19) United States
(12) Patent Application Publication
(10) Pub. No.: US 2017/0217673 A1
(43) Pub. Date: Aug. 3, 2017

(54) CLOSURE ARRANGEMENT, METHOD FOR CLOSING A CLOSURE, BULK MATERIAL CONTAINER, DOCKING DEVICE, AND METHOD FOR CLOSING A DOCKING DEVICE

(71) Applicant: VISVAL AG, Düdingen (CH)

(72) Inventors: Jean-Marie CUENNET, Bern (CH); Filip GIANETTONI, Gordola (CH); Gabriele BORDOLI, Bellinzona (CH)

(73) Assignee: VISVAL AG, Düdingen (CH)

(21) Appl. No.: 15/308,145

(22) PCT Filed: May 1, 2015
(86) PCT No.: PCT/CH2015/000070

§ 371 Date: Nov. 1, 2016

(30) Foreign Application Priority Data
May 2, 2014 (EP) 14 405 040.8

(51) Int. Cl. B65D 90/62; B65G 65/30; B65G 69/08; B65G 69/18; B65D 90/66; B65B 1/22

(52) U.S. Cl. CPC B65D 90/626; B65D 90/66; B65B 1/22; B65G 69/08; B65G 69/183; B65G 65/30; B65D 2590/542; B65D 2590/662; B65D 2590/666

(57) ABSTRACT

The invention relates to a seal assembly comprising: a seal for a bulk material container, having a ring-shaped connecting flange with a through opening and a first moving element; and a seal member for selectively sealing or opening the through opening. A container wall of the bulk material container can be attached to the connecting flange. The seal assembly also comprises a docking device having a housing, a second moving element, and a seal actuating device. In order to increase the tightness of the seal, one of the moving elements comprises a peripheral first stripping element, by means of which impurities are stripped from a surface of the connecting flange, in a closing process for sealing the though opening of the connecting flange.

### TECHNICAL FIELD

The invention relates to a closure arrangement having a closure for a bulk material container, which comprises an annular connection flange having a through-opening, and a closure member for selectively closing or opening the through-opening, wherein a container wall of the bulk material container is able to be fastened to the connection flange. Furthermore, the invention relates to a method for closing such a closure and also to a bulk material container having such a closure and to a docking device for docking such a closure of a bulk material container.

### PRIOR ART

Bulk materials, such as pulverulent or granular substances or fluids such as gaseous or liquid substances, for example, are often stored for transport or storage in special bulk material containers. Such bulk material containers can be configured for example as sacks or barrels and consist of a wide variety of materials such as textiles, plastics or metals. They can also consist of a mixture of different materials and be configured in one or more layers.

In order to empty bulk material out of such bulk material containers, the latter typically comprise a closure which can be connected to a corresponding connection part of an emptying device configured therefor. The closure typically comprises a closure member with which an opening in the container wall can be selectively closed or opened.

Visval AG's EP 1 574 455 A1 shows such an emptying device (10). Said device comprises a connection part (24) to which a corresponding connection flange (51, 52) of a bulk material container (50) can be connected. The opening in the connection flange is closable by a closure member (60). Furthermore, the emptying device (10) comprises a closure actuating element (34) which is mounted in a displaceable manner and with which the closure member (60) of the bulk material container (50) connected to the emptying device (10) is displaceable such that the opening in the connection flange (51, 52) can be selectively opened or closed thereby. With the opening open, bulk material can then be removed from the bulk material container through this opening. If the bulk material container is arranged, as usual, above the emptying device, the bulk material flows or runs out of the container virtually by itself with the closure open, wherein the emptying operation can be supported by compressed air being blown into the bulk material container. In order to prevent bulk material from passing between the connection part (24) and the connection flange (51, 53) during emptying, several sealing rings (41, 42, 43) are provided. The innermost sealing ring (43) is in this case arranged around the outer periphery of the inlet opening (26) and seals off the inlet opening or through-duct (22) in the top side of the connection part (24).

Another emptying device is shown in WO 96/10709 A1 (Matcon). The closure element disclosed has a conical portion and a cylindrical portion. Attached to the outer periphery of the cylindrical portion is a C-shaped seal. When a container is completely closed by the closure element, a sealing lip of the C-shaped seal provides additional sealing. As a result of the sealing lip having a bulbous seal part, which also retains the seal in the correct position in the event of radial pressure, foreign bodies are prevented from passing between the closure element and seal.

WO 98/43902 A1 (Matcon) discloses a further emptying device for discharging flowable medium from a container. The emptying device comprises a pipe, a closure and a cleaning device. By lifting or lowering, the closure opens or closes the passage to the pipe. Located at the upper edge of the pipe is an annular seal. This seal has a radially inwardly protruding part, which projects into the pipe and seals the pipe off with respect to the closure when no container has been placed on the emptying device. Located at the upper end of the pipe is the annular cleaning unit, to which a likewise annular flexible sealing lip has been attached. This sealing lip in turn has a radially inwardly protruding part, which comes into contact with the surface of the closure and is parallel to the lower seal. If a container is placed on the discharging station, the sealing lip and the seal are expanded and bent downward. As a result of tensile stress, a sealing action is achieved such that the interior of the container is sealed off from the outside.

One of the disadvantages of these emptying devices is that bulk material, in particular fine bulk material, is not completely prevented from sticking between the closure member and the connection flange of the closure when the closure is closed and thus being able to have a negative influence on the sealing of the closure.

Furthermore, the sealing of the docking device is also not completely ensured. Specifically, it is also not possible to prevent bulk material from being able to escape from the gap between the connection part and the closure actuating element during or after the closing of the inlet opening with the closure actuating element. The seal described in WO 98/43902 for sealing off the docking device when no container is attached solves this problem only partially. The disclosed seal having a sealing lip has the disadvantage that, as a result of the continuous expansion of the inside diameter of the seal becomes larger over time. As a result, the impermeability with a container in position decreases continually and, in particular when no container is in position, it is no longer possible to seal off the overall system, since the inside diameter of the seal no longer comes into contact with the movable closure element, or only comes into contact therewith very weakly.

### SUMMARY OF THE INVENTION

It is the object of the invention to create a bulk material container closure which belongs to the technical field mentioned at the beginning and which has better impermeability.

The achievement of the object is defined by the features of claim 1. The invention is a closure arrangement which comprises a closure for a bulk material container and a docking device. The bulk material consists for example of pulverulent or granular substances. Of course, it is also possible to process liquids or fluids in general, i.e. also gaseous substances, therewith, however. The closure comprises an annular connection flange having a through-opening and also a first movable element, namely a closure member, for selectively closing or opening the through-opening. In its closed position, the closure member is accordingly arranged in the inner region of the annular connection flange. The docking device comprises a housing and a second movable element, namely a closure actuating device. The closure actuating device moves the closure member relative to the connection flange and perpendicularly to the plane of the through-opening in order to close or open the through-opening. The closure actuating device comprises an adjusting device and a closure actuating element. The closure actuating element in this case moves the closure member between the open position and the closed position.

The closure is configured in this case such that the container wall of a bulk material container is able to be fastened to the connection flange. Depending on its nature, the container wall can for example be welded to the connection flange, adhesively bonded thereto or fastened thereto in some other way.

According to the invention, one of the movable elements now comprises a peripheral, first stripping element such that contaminants are able to be stripped from a surface of the connection flange by the closure member during a closing operation for closing the through-opening in the connection flange. This stripping element is formed for example as a peripheral edge.

While this first stripping element on one of the movable elements rubs along the inwardly directed surface of the connection flange while the connection flange is being closed with the closure actuating element, bulk material or other contaminants which stick there in an undesired manner are removed from this sealing region between the closure member and the connection flange. Since the contaminated region is cleaned with the sealing faces before the seals bear against the sealing faces, the impermeability of the closure is already considerably improved.

In the following text, the docking device is sometimes also referred to as an emptying device. However, this term should not be understood in such a way as to include only devices for emptying a bulk material container but also—as long as nothing else is apparent from the context or nothing else is mentioned—devices which are suitable both for emptying and for filling bulk material containers.

Since the filling or emptying openings of the closures of such bulk material containers and also corresponding docking devices are generally annular, usually even rotationally symmetrical, i.e. in the form of a circular ring, the connection flange and the closure member are accordingly also preferably formed in a rotationally symmetrical manner. This not only makes it easier to handle these devices during emptying and filling but also makes them easier to produce and they are furthermore also easier to design so as to be compatible with existing installations.

In a preferred embodiment of the invention, the connection flange comprises several, in particular annular flange elements, wherein the container wall can be clamped between two or more flange elements in this case. Here, the container wall can already comprise an opening in which the closure is fastened. This is not necessarily the case, however. This is because the closure and the process of mounting the closure in or on the container wall can also be configured such that the container wall remains intact in the entire region of the closure and the opening for emptying the bulk material is created only shortly before or during the emptying operation.

If the closure is now connected for example to the connection part of the emptying device, the closure member is moved by a movement of the closure actuating element of the emptying device, wherein the connection flange remains fixedly connected to the connection part, such that the through-opening is selectively closed or opened.

In order that the connection flange of a bulk material container can be coupled as impermeably as possible to the connection part of an emptying device, the emptying device advantageously comprises a locking device for connecting the connection flange of the bulk material container to the connection part of the emptying device in a force-fitting manner. This can be configured for example such that it is manually actuable. However, it is preferably configured for automatic actuation and comprises for example a kind of clamp, clip or other clamping or pressing device which is placed around the connection flange and the connection part and can be actuated such that the connection flange and connection part are pushed onto and against one another, respectively. Such a locking device is known for example from EP 1 574 455 A1.

This first stripping element efficiently prevents any contaminants from sticking to the inner side of the connection flange. However, any contaminants on the outer side of the closure member are not removed thereby. In order also to remove such contaminants, a peripheral, second stripping element is advantageously arranged on the connection flange in the region of the through-opening. Said second stripping element is arranged such that it strips contaminants from a surface of the closure member during a closing operation for closing the through-opening with the closure member. This surface is accordingly the inner surface, i.e. that surface of the connection flange that is directed into the interior of the through-opening. The second stripping element is also configured for example as a peripheral edge.

In a preferred embodiment of the invention, the first stripping element or the second stripping element or in particular both are also configured at the same time as a retaining or clamping device in order to retain the closure member in its closed position on the connection flange. They can be configured for example as a detent or as a type of tongue element which cooperates with a corresponding groove in the connection flange or in the closure member.

The shape of the closure member is in principle freely selectable, wherein, like the connection flange, it is advantageously configured in a rotationally symmetrical manner. This not only makes production easier but also the mounting and general handling of the closure and its components. The closure member can be configured for example as a flat disk or as a cylindrical element, wherein its inner side, directed into the interior of the bulk material container in the mounted state, can be configured both in a convex and in a concave manner. However, it should be noted that the closure member is located precisely in the flow area of the bulk material during the emptying of a bulk material container. Nevertheless, in order that, during the emptying operation, as little bulk material as possible, if any, gets caught or remains on the inner side of the closure member or the closure member impedes the flow-out operation as little as possible, the closure member comprises a conical portion and a cylindrical portion adjoining the latter. The closure is then fastened in the container wall such that the tip of the conical portion points into the interior of the container and accordingly the cylindrical portion adjoins the wide end of the conical portion. In the closed position of the closure member, the inner region of the connection flange and the outer periphery of the cylindrical portion of the closure member are accordingly located opposite one another.

In a preferred embodiment of the closure arrangement according to the invention, the first stripping element is arranged in an end region of the closure member that is remote from the conical portion. This ensures that the first stripping element frees as far as possible the entire inner side of the connection flange, i.e. from top to bottom, of contaminants.

In a further preferred embodiment, the first stripping element is arranged on the closure actuating element. The stripping element is in this case attached to the outside of the closure actuating element on a cylindrical portion of the closure actuating element that is directed toward the inner side of the closure flange.

Compared with the embodiment in which the stripping element is arranged on the closure member, this embodiment affords the advantage that a frictional force generated by the first stripping element does not arise at the closure member and thus has to be transmitted via the connection between the closure member and closure actuating device. Instead, the frictional force of the first stripping element arises directly at the closure actuating device and can be exerted, or absorbed, without problems by the adjusting device.

The second stripping element can in principle be attached anywhere on the inner surface of the connection flange. However, it is advantageous for it to be arranged such that it comes to lie above the first stripping element when the closure member is in its closed position. Or, in other words, the second stripping element is arranged on the connection flange such that, in a closed position of the closure member in which the latter closes the through-opening, it is located opposite a region of the cylindrical portion which is located closer to the conical portion of the closure member than the first stripping element. Advantageously, the second stripping element is arranged in the inlet region of the connection flange, i.e. at the upper end of the inwardly directed surface of the connection flange.

This ensures that, when the closure member is closed, no surface region of the connection flange is located opposite the cylindrical portion, which has not previously been cleaned by the second stripping element, of the closure member. This results in a further considerable improvement in the in any case already good sealing action between the closure member and connection flange.

In a further preferred embodiment of the invention, in order to provide sealing between the connection flange and the closure member in a closed position of the closure member in which the latter closes the through-opening, the closure comprises an annular closure seal. The latter is preferably produced from an elastically deformable material. It consists for example of a material known for such applications, in particular of a dimensionally stable, elastically deformable plastics material, preferably of an elastomer such as EPDM (ethylene propylene diene rubber), silicone rubber, etc. This also goes for the seals or seal elements mentioned in the following text. Since the closure member is located in the inner region of the connection flange when it is in its closed position, the closure seal is also arranged in particular in an inner region of the annular connection flange. However, it can also be attached to the cylindrical portion, directed outwardly toward the inner side of the connection flange, of the closure member. While the two stripping elements ensure that no contaminants are located between the connection flange and the closure member in the closed position any more, this closure seal optimally seals off this region and prevents material, i.e. in particular bulk material, from passing undesirably out of or into the bulk material container.

A material that is not elastically deformable, in contrast to the seals, is highly suitable as the material for the closure member or the connection flange, preferably for both. It may be for example a polymer material such as a thermoplastic or thermosetting material, for instance, wherein use is preferably made of a thermoplastic material, since the latter is weldable. Polypropylene or polyethylene has been found to be particularly suitable for this purpose. Metal embodiments are of course also possible. Thus, for example, steel, in particular stainless steel, is very suitable for this purpose, but aluminum would also be quite possible. Moreover, it is also possible to produce either the connection flange or the closure member from a metal and the respectively other element from a polymeric material.

By contrast, an elastically deformable material is advantageously used as the material for the first or the second stripping element, preferably for both. This material has the advantage that, when the stripping elements rub along the respectively opposite surface, they can adapt better to the respective surface profile and thus improve the cleaning result. The stripping elements can also be formed from a material that is not elastically deformable or is only a little elastically deformable, wherein, in such a case, the surface regions should not have excessive curvatures in order that they can also be cleaned correctly. In this case, the necessary deformation is also supported for example by the geometry of the cooperating elements, namely the connection flange and closure member.

According to the invention, in order to provide sealing between the housing and the closure actuating element in a closed position, the docking device comprises a seal made of an elastically deformable material that is arranged on the closure actuating element.

In a preferred variant embodiment, the first stripping element can also be configured as such a seal at the same time. However, the seal can also be configured in the form of a separate formation in the stripping element. In both cases, the stripping element is arranged with a sealing action on the second movable element, namely on the closure actuating element. The seal corresponds to the seal described further below in this document.

A combination of the stripping element and seal affords the advantage that two functions can be combined in one element and thus a compact and cost-effective design is allowed. Therefore, only one cutout has to be provided in the closure actuating element rather than two cutouts for the stripping element and the seal.

The seal is under radial compressive stress in the closed position and without a closure of a bulk material container being connected to a connection part, such that the seal is pressed against an active region of the connection part. The detailed description of the seal can be found further below.

A further object of the invention is to create a method, which belongs to the technical field mentioned at the beginning, for closing a closure according to the invention, said method resulting in better impermeability of the closure.

The achievement of the object is defined by the features of claim 11. The invention is a method for closing a closure, as has been described above. For closing, the closure member is moved in a direction of movement perpendicular to the through-opening from an open position, leaving the through-opening open, into a closed position, closing the through-opening, of the closure member, wherein contaminants are stripped from an inner surface of the connection flange by the first stripping element arranged on one of the movable elements.

In a preferred embodiment of the method according to the invention, contaminants are of course also stripped from an outer surface of the closure member by the second stripping element arranged on an inner side of the connection flange.

In order to further increase the impermeability of the closure, it is possible for the closing operation to be carried out not just once but preferably several times, i.e. two or more times. In other words, after the connection flange has been closed, the closure member is moved in the direction of the open position again and then back into the closed position. In this case, it should be noted, however, that when the closure member is moved in the direction of the open position, the closure is not opened again to such an extent that bulk material can flow out of the bulk material container, recontaminating the already cleaned surfaces. In this way, further contaminants are stripped off a surface of the connection flange and in particular also from an outer surface of the closure member. This operation is now repeated in particular two or more times.

The movement of the closure member in the direction of movement can take place in various ways. For example, it can be moved manually or it can be moved by an adjusting device arranged on the closure or on the bulk material container. However, in such a preferred embodiment of the method according to the invention, the closure member is moved in the direction of movement by a closure actuating element of a docking device for docking the closure for emptying or filling a bulk material container comprising the closure.

The invention also relates to a bulk material container. This container has a container wall and a closure, as has been described above. According to the invention, the container wall is in this case fastened to the connection flange of the closure.

The container wall can in this case be made of one layer, wherein, as already mentioned, it can be fastened to the connection flange of the closure, for example welded thereto or clamped between several elements of the connection flange. It can, for example, also be adhesively bonded to the connection flange, screwed thereto or fastened thereto in some other way. The container wall can also be configured in a multilayer manner, as is the case for instance in a barrel having an inliner, where the outer layer is formed for example by a metal or plastics barrel and the inliner typically consists of a weldable plastics material or a textile material. Of course, in the case of multilayer container walls, it is also possible for all or several layers to consist of the same material. In addition, even in the case of multilayer container walls, all of the layers are fastened or able to be fastened to the connection flange of the closure. The connection flange can consist for example of three annular flange elements, wherein an inner layer is fastened between the innermost and the middle flange element and the outer layer is fastened between the middle and the outermost flange element.

A further object of the invention is to create a docking device, which belongs to the technical field mentioned at the beginning, for docking a closure of a bulk material container in order to empty bulk material from the bulk material container and/or fill the bulk material container with bulk material, said docking device again having improved impermeability.

The achievement of the object is defined by the features of claim 14. The docking device comprises a housing and a connection part for connecting a closure. The connection part is configured for example such that a connection flange of a closure of a bulk material container can be connected or coupled thereto in an impermeable manner. The docking device also comprises a closure actuating device for actuating a closure of a connected bulk material container. The closure actuating device in turn comprises a closure actuating element and an adjusting device with which the closure actuating element is movable selectively between a closed position and an open position. The closure of the bulk material container is in this case actuated such that for example a part thereof is moved from a closed position into an open position, and vice versa, with the aid of the closure actuating element. The movement of the closure actuating element takes place in this case up and down or back and forth, depending on the position, in a particular direction of movement. It should be noted that there are preferably several open positions and exactly one closed position, between which the closure actuating element is moved back and forth. In a particularly preferred variant of the invention, there are virtually as many open positions as desired, since the closure actuating element can be moved steplessly into any desired position between the closed position and a maximum open position. However, the adjusting device can also be configured such that the closure actuating element can take up only exactly one open position and/or several closed positions.

In the case of solid substances or liquids, in order to be emptied, the bulk material container is typically positioned with its opening downward and the docking device is arranged beneath the bulk material container, such that the bulk material can flow out downwardly on account of gravity. This is also the case for high-density gaseous substances, meaning in the present case that the gas does not experience any buoyant lift with respect to the environment. Correspondingly, for low-density gaseous bulk material (which experiences buoyant lift), the bulk material container is positioned with its opening upward and the docking device above the bulk material container, in order that the bulk material can flow out upward on account of the uplift.

According to the invention, the docking device comprises a seal which serves to provide sealing between the housing and the closure actuating device in the closed position and without a closure of a bulk material container being connected to the connection part.

The seal is under radial compressive stress in the closed position and without a closure of a bulk material container being connected to a connection part, such that the seal is pressed against an active region of the connection part. The connection part is arranged in the upper part of the housing of the docking device. The connection part can therefore be considered part of the housing of the docking device or as a separate element from the housing.

The seal consists of a material known for such applications, in particular of a dimensionally stable, elastically deformable plastics material, preferably of an elastomer such as EPDM (ethylene propylene diene rubber), silicone rubber, etc. This also goes for the seals or seal elements mentioned in the following text.

The sealing action of the seal is based on the radial, fatigue-free compressive stress. Thus, the seal does not have to be expanded or stretched, which would result in material fatigue and thus in a decreasing sealing action. The advantage of this seal is also that the sealing action is not dependent on the inherent stress in the seal and the tensile stress in the seal, and that the radial pressure force remains constant. This ensures permanent overpressure-protected dust- and gas-tightness of the overall system, in particular even when no bulk material container is docked to the docking device.

Since, on the one hand, such a seal is arranged between the closure actuating element and the housing of the docking device, this prevents for example foreign particles—from wherever—from being able to pass unintentionally into the docking device and, on the other hand, prevents bulk material or vapors and gases from being able to escape from the docking device. Accordingly, in this way, the contamination of the outer surface of the closure actuating element, of the docking device and generally of the environment with bulk material or vapors and gases is also prevented.

Since the filling or emptying openings of the closures of such bulk material containers are at least annular, usually even rotationally symmetrical, i.e. in the form of a circular ring, the seal is likewise annular in a preferred embodiment of the invention and advantageously just configured in a rotationally symmetrical manner and arranged around an outer periphery of the closure actuating element.

Alternatively, the seal could also consist of several individual portions which are placed against one another. However, there is the risk of a lack of impermeability at each transition between two portions with such an embodiment.

The seal preferably comprises a seal portion having an active region, wherein this active region is pressed onto an active region of the connection part.

In a preferred variant embodiment, the seal portion is a sealing lip directed radially outward toward the connection part. However, the seal portion can also represent any desired part of the seal which is suitable for bringing the seal into contact with the active region of the connection part.

The active region can be in the form of a surface, linear or virtually punctiform. As a result of the pressure force of the active region of the seal portion of the seal on the active region of the connection part, the sealing action is in each case ensured and improved.

In a further preferred embodiment of the invention, the annular seal comprises a base in the form of a circular ring and a seal portion in the form of a circular ring that is integrally formed on the base and extends radially outward with regard to the direction of movement. In order to achieve a good sealing action, the outside diameter of the seal portion in the form of a circular ring is advantageously greater than an inside diameter of the surface portion on an inner side of the housing, said surface portion being located opposite the seal portion in a closed position of the closure actuating element. The seal portion cooperates in a sealing manner with this surface portion.

The shape of the seal, i.e. the shape of the cross section of the seal, in that region which is crucial for the sealing action between the housing and the closure actuating element, can be configured for example in an oval, elliptical or round manner. This region is also referred to as active region in the following text. This active region can also be configured in a rectilinear manner, wherein the orientation thereof is in principle freely selectable. The shape of the active region can of course also be selected depending on the shape of the housing or of the closure actuating element in the region where sealing is intended to be achieved. These regions of the housing and also of the closure actuating element are preferably oriented axially, i.e. extend parallel to the direction of movement of the closure actuating element in this region. The reason for this is in particular so that the emptying of the bulk material can take place in as free-flowing a manner as possible and not be impeded by portions of the housing or of the closure actuating element which encroach on the flow area of the bulk material, as would be the case in a non-axial orientation of the corresponding regions of the housing or of the closure actuating element.

The seal portion is configured for example in a substantially rectangular manner and integrally formed on the base with a short side. The active region is in this case formed on a free end side of this portion. In this way, not only is the desired radial sealing action between the active region arranged on the end side and the housing or the closure actuating element achieved, but also the free end of this cross-sectionally rectangular portion is furthermore mobile. It can thus be moved to a certain extent in the direction of movement of the closure actuating element. This is useful in particular when a closure of a bulk material container is connected to the connection part of the docking device. In this case, the seal between the housing and the closure actuating element is of course intended to be removed in order that the bulk material can flow out of the container in an unimpeded manner. This can now be achieved in a simple manner in that that part of the closure of the bulk material container that is actuated by the closure actuating element pushes the free end of this cross-sectionally rectangular portion away out of its radial position during coupling to the connection part.

In order to make this pushing-away easier, the seal portion is preferably formed in a relatively elongate manner in cross section, such that its length is significantly greater than its width. In this case, the length should be selected such that it is slightly greater than the radial distance between the base and the inner surface of the housing portion, which is located opposite the seal portion in a closed position of the closure actuating element. As a result, the seal portion is compressed slightly when the closure actuating element is positioned in its closed position, this having the consequence of increased radial stress, resulting in a particularly good sealing action between the housing and the closure actuating element.

As already mentioned, the seal serves to provide sealing between the housing and the closure actuating element of the docking device. It can thus be arranged in principle on one of these two elements. In one preferred embodiment of the invention, the seal is arranged on the closure actuating element. This has the advantage that the seal can be used not only to provide sealing between the housing and closure actuating element but also at the same time to provide sealing between the closure actuating element and the closure member of a coupled bulk material container. This has the objective of protecting the outer region of the closure actuating element from contamination with bulk material. The outer region is understood here to mean the external region as seen from the housing.

Such sealing between the closure actuating element and that part of the closure that is actuated thereby can of course also or additionally take place by means of separate seal devices. However, this preferably takes place in that the seal comprises at least one further seal region which serves to provide sealing between the closure actuating element and the closure of a bulk material container connected to the docking device. Such a seal region can be configured for example as a lip seal. The seal thus not only prevents contamination of the outer surface of the closure actuating element with bulk material, but also outer surface, i.e. the side, facing the closure actuating element, of that part of the closure that is actuated thereby.

The sealing between the housing and the closure actuating element can take place by way of a seal arranged on the closure actuating element, said seal cooperating, by way of its active region, directly with a surface region of the housing in a radially sealing manner. However, it can also take place by way of a seal arranged on the housing, said seal cooperating, by way of its active region, directly with a surface region of the closure actuating element in a radially sealing manner.

Preferably, however, the docking device comprises a further sealing element made of an elastically deformable material, which comprises an active region that is oriented axially with regard to the direction of movement. This sealing element is in this case arranged on the housing of the docking device such that, in the closed position of the closure actuating element and without a closure of a bulk material container being connected to the connection part, a radial sealing action results between the active region of this sealing element and the active region of the seal arranged on the closure actuating element. In other words, the sealing action is achieved not between the seal and the housing material itself, but between the seal and the further sealing element. Although this further sealing element is configured as a separate element, it should be understood as being part of the housing in the context of the present invention.

Of course, it is also possible for the seal, as already mentioned, to be arranged on the housing, wherein the additional sealing element is arranged on the closure actuating element in this case and should accordingly be understood as being part of the closure actuating element.

Although sealing between the housing of the docking device and a closure, connected thereto, of a bulk material container is in principle not absolutely necessary, such sealing is advantageous or indispensable in practice depending on the type of bulk material. In a preferred embodiment of the invention, the docking device therefore comprises a flange seal, arranged on the connection part, for providing sealing between the connection part and a connection flange of a bulk material container closure connected to the docking device.

Preferably, the active region of the closure part is oriented parallel to the direction of movement. This affords the advantage that the active region of the seal, which is arranged on the closure actuating element, is parallel to the active region of the closure part and thus the radial compressive stress of the seal can be absorbed optimally by the active region of the connection part.

The active region of the connection part can, however, also be at any desired angle to the direction of movement, wherein the angle is typically preferably between 45 degrees and 90 degrees, rather than under 45 degrees.

In a further embodiment, the seal can have a stripping element which strips contaminants from a surface of the connection flange during a closing operation for closing the through-opening in the connection flange with the closure actuating element. This stripping element corresponds to the first stripping element already described further above. In this case, the stripping element can be arranged on the seal in the form of an additional protruding formation. However, the stripping element can also be integrated into the radially protruding seal portion of the seal. Naturally, the seal itself can also be configured as a stripping element. In both cases, the seal with the stripping function is arranged on the second movable element, namely the closure actuating element.

This embodiment affords the advantage that the sealing element and the stripping element can be produced as one unit. A disadvantage is the complicated cross-sectional form which results when the stripping element is configured as an additional formation.

The stripping element and the seal can thus be combined in one element. The stripping element and also the seal can also be completely separate, however, and are functionally independent of one another.

Depending on the nature of the bulk material, said bulk material flows virtually by itself and completely out of the bulk material container. Measures for fluidizing the bulk material are then superfluous. However, it is possible for this not to happen and for the bulk material not to flow out of the bulk material container by itself or to flow out of the latter only slowly or not completely. For example because it has clumped together during storage or transportation or what are referred to as bulk material bridges have formed. In order to fluidize the bulk material, i.e. to loosen it up, to improve the flow properties, the docking device can be provided, as in EP 1 574 455 A1 mentioned at the beginning, with a pneumatic gas device by means of which compressed air or some other fluidizing gas is able to be blown into the bulk material container.

In order to support the emptying operation and/or the filling operation, the docking device advantageously comprises a vibration unit, however, with which it is able to be set in vibration. The vibration unit can be arranged for example inside the housing or the closure actuating device. However, it is preferably fastened or able to be fastened to the outside of the housing. This arrangement ensures good fluidizing of the bulk material during emptying, since the vibrations of the vibration unit are readily transferable from the housing to the closure and to the container wall of the bulk material container via the connection part in this way. During filling, the vibration unit serves in particular for better distribution and also for compaction of the bulk material in the bulk material container. Such a vibration unit is advantageous in particular in the case of comparatively small docking devices because, in the case of the latter, the available space in the housing is limited and for example there is scarcely any space for a pneumatic gas device. A comparatively small docking device comes into question when the diameter of its through-opening for emptying the bulk material is less than 200 mm, for example in the range from 50 mm to 150 mm. However, it is also possible to provide an external vibration unit in the case of larger docking devices with through-openings larger than 200 mm, wherein such a vibration unit can of course also be arranged inside the housing or the closure actuating element.

It is also possible to provide two or more vibration units for fluidizing the bulk material. The amplitude and the frequency of the vibrations of each vibration unit can be matched to the properties of the bulk material in this case.

The invention also relates to a method for closing a docking device. In the method according to the invention, the closure actuating element is moved in a first step beyond the closed position from the open position in a closing direction in the direction of the closed position. In a second step, the closure actuating element is moved counter to the closing direction into the closed position.

In this case, “in the closing direction” means that the closure actuating element is moved from the open position in the direction of the closed position. An open position is provided in a preferred variant when the closure actuating element has been moved upward such that an annular opening arises between the closure actuating element and connection flange. “In the closing direction” in this case means that the closure actuating element is moved from top to bottom in order to close the opening and in order to achieve the closed position. Alternatively, however, the open position can also be defined such that the closure actuating element is located beneath the connection flange. In this case, “in the closing direction” means a direction from bottom to top.

The outside diameter of the seal is larger than the inside diameter of the connection part. Consequently, a part of the seal that projects toward the connection part is present at an outer edge of the connection part in the first step. Upon moving further in the closing direction, this part of the seal is pushed away counter to the closing direction. In the second step, when the closure actuating element is moved a little counter to the closing direction again, that part of the seal that projects toward the connection part catches on an edge on an inner side of the connection part such that this part cannot move further counter to the closing direction. In this way, that part of the seal that projects toward the closure part is kept in position. This part of the seal is transferred into the horizontal by the further movement of the closure actuating element and is simultaneously compressed, with the result that the radial compressive stress in the seal arises. As a result of this radial compressive stress in the seal, a particularly good and consistent sealing action is achieved.

In the first step, the closure actuating element is moved beyond the closed position by a distance D, wherein the distance D corresponds to at least one time and at most three times an extension in the direction of movement of a contact region between the seal and the connection part in the closed position. Alternatively, the distance D can also correspond to at most four to five times an extension in the direction of movement of a contact region of the seal.

In a preferred embodiment, the closure actuating element is located above the connection flange in the open position. Consequently, in this embodiment, the closing direction is vertically from top to bottom. This affords the advantage that, during a closing operation, the closing direction coincides with the dropping direction of the bulk material and thus the risk of jamming is minimized.

As already mentioned, the closure actuating device comprises a closure actuating element and an adjusting device with which the closure actuating element is adjustable in a direction of movement. The adjusting device can comprise for example merely a handle or the like with which the closure actuating element can be moved manually in the direction of movement. Preferably, however, the adjusting device comprises a drive device with which the closure actuating element can be moved in the direction of movement. This movement can take place for example by manual actuation of corresponding elements of the drive device; for example, a rotary movement that is produced manually by rotation of a crank or of a handwheel or the like can be converted into a movement of the closure actuating element by a corresponding clutch and/or a corresponding gear mechanism.

However, if the bulk material containers have to be emptied automatically or a large number of emptying operations are required, for example, it is advantageous for the movement of the closure actuating element not to take place manually but rather by way of a drive unit such as a motor, for example. Since such docking devices are frequently used in sensitive sectors such as in food processing or in the chemical or pharmaceutical industry, drive devices which are operated with liquid or gaseous fuels, such as gasoline, natural gas or the like, are rather unsuitable, although they can also be used in principle. Therefore, the drive unit advantageously comprises an electric motor, wherein any kind of electric motor is usable in principle. However, a brushless electric motor is advantageously used in order that mechanical abrasion can be reduced or avoided. In addition, a controller can be provided, with which the electric motor can be controlled in different ways depending on the application. Thus, for example, the acceleration, rotational speed and number of revolutions of the motor can be selected within wide ranges and optimized for the particular application. However, depending on the application, it is of course also possible to use hydraulic or pneumatic drives or any other kind of drive.

In a preferred embodiment of the invention, the adjusting device comprises a spindle, wherein the closure actuating element is fastened to the spindle and is accordingly adjustable by an axial movement of the spindle.

Such an axial movement of the spindle is achievable in a wide variety of ways. For example, it can be achieved such that the rotation of the motor shaft is transferred to the spindle via a worm gear or the like. The spindle moves in this case in the axial direction without intrinsic rotation. However, it is also possible in principle to set the spindle into a rotary movement with the aid of the motor, wherein the spindle comprises for example a thread which runs in a fixed nut such that the rotating spindle is displaced in the axial direction.

Depending on the selected coupling or thread between the motor and spindle, the drive unit can be coupled for example axially to the spindle. However, the drive unit would then typically be located in or beneath the housing of the docking device such that it would be located in the flow area of the bulk material. Therefore, the drive unit is preferably arranged radially with respect to the spindle.

In this case, the rotary movement of the drive unit typically has to be converted into a movement of the spindle perpendicular thereto. To this end, the drive device preferably comprises an angular gear. In principle, any kind of gear mechanism which converts a rotary movement about a first axis into a rotary movement about a second axis which is not parallel to the first axis can be used for this purpose.

In order to make do with as little drive power as possible, the drive device is configured in particular as a ball screw. Such a drive device additionally has the advantage that it exhibits little wear and allows high displacement speeds and high positioning accuracy.

Since, during emptying and filling of bulk material containers, the bulk material flows through the interior of the docking device and consequently there is the risk that everything located therein will come into contact with bulk material, the motor and of course any controller are preferably arranged outside the housing or fastened to the outside of the latter. The motor shaft or a transmission device coupled thereto is then guided through the housing. In order also to avoid contamination of all of the parts of the drive train that are arranged within the housing, said parts are preferably embodied in an encapsulated manner. Thus, at most the encapsulation is contaminated, this not having any influence at all on the function of the drive train.

Further advantageous embodiments and combinations of features of the invention can be gathered from the following detailed description and the entirety of the patent claims.

### BRIEF DESCRIPTION OF THE DRAWINGS

In the drawings used to explain the exemplary embodiment:

FIG. 1 shows a schematic illustration of a closure according to the invention in a slightly open position;

FIG. 2 shows the closure from FIG. 1 in a closed position;

FIG. 3 shows an enlarged illustration of a detail from FIG. 1;

FIG. 4 shows a schematic illustration of the inventive principle of mutual cleaning of the closure member and connection flange in an open position;

FIG. 5 shows a schematic illustration of the closure member and of the connection flange from FIG. 4 in a closed position;

FIG. 6 shows a schematic illustration of a docking device according to the invention with a connected bulk material container and the closure closed;

FIG. 7 shows a schematic illustration of the docking device from FIG. 6 with the closure open;

FIG. 8 shows an enlarged illustration of a detail of the docking device from FIG. 6 with the bulk material container uncoupled;

FIG. 9 shows a schematic illustration of a further docking device according to the invention without a coupled bulk material container;

FIG. 10 shows an enlarged illustration of a detail of the docking device from FIG. 9 with the bulk material container uncoupled;

FIG. 11 shows an enlarged illustration of the same detail from FIG. 9 with a coupled bulk material container;

FIG. 12 shows an enlarged detail of the connection part of the docking device from FIG. 4 with the closure from FIG. 7 connected thereto;

FIG. 13 shows a schematic illustration of a further closure according to the invention with an uncoupling device, coupled to a docking device;

FIG. 14 shows a schematic illustration of the closure from FIG. 13 uncoupled from the blocking device;

FIG. 15 shows a schematic illustration of the inventive principle of the mutual cleaning of the closure member and connection flange in an open position with a stripping element arranged on the closure actuating element and a stripping element arranged on the connection flange;

FIG. 16 shows a schematic illustration of the closure actuating element and of the connection flange from FIG. 15 in the closed position;

FIG. 17 shows a schematic illustration of the closure with a stripping element arranged on the closure actuating element; and

FIG. 18 shows a schematic illustration of the closure with a stripping element integrated in the seal.

In principle, identical parts are provided with the same reference signs in the figures.

### Ways of Implementing the Invention

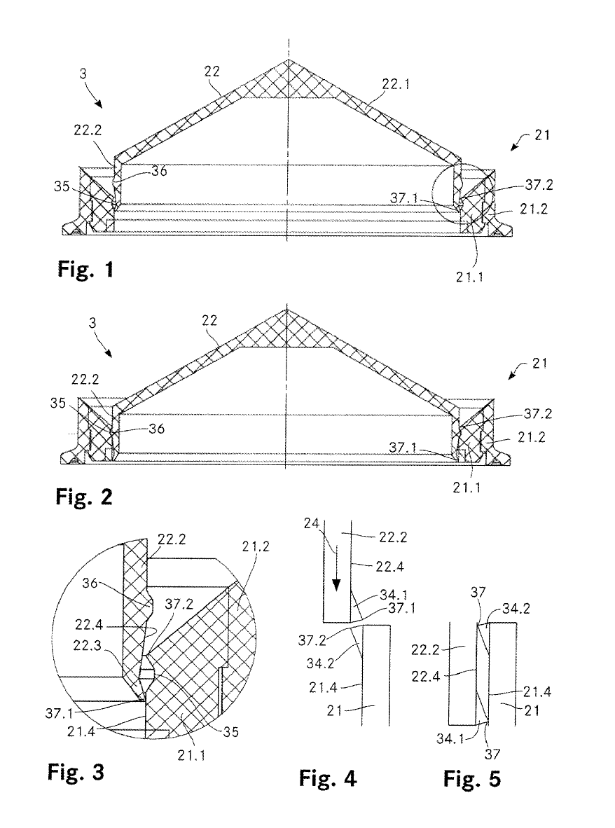

FIGS. 1 and 2 show a schematic illustration of a closure 3 according to the invention in cross section. In FIG. 1, the closure 3 is illustrated in a slightly open position and in FIG. 2, it is illustrated in a closed position. FIG. 3 in turn shows an enlarged illustration of a detail showing the region of contact between the cone valve 22 and the connection flange 21.

The closure 3 in turn comprises a cone valve 22 which has a conical portion 22.1 and a cylindrical portion 22.2. However, in contrast to the previous examples, the connection flange 21 comprises two flange elements, namely an inner flange element 21.1 and an outer flange element 21.2. The two flange elements are configured such that the inner flange element 21.1 can be fastened in the outer flange element 21.2, for example welded therein, such that together they form a unit. The flange elements 21.1, 21.2 can for this purpose also have for example corresponding structures which reinforce the cohesion of the two elements and make it difficult to subsequently take them apart or prevent this. Such structures can be configured for example in a similar manner to a clip closure or snap-action closure. In the embodiment illustrated, for instance, the inner flange element 21.1 comprises a peripheral groove on its outer periphery and the outer flange element 21.2 comprises a matching tongue on its inner periphery.

In a connection flange 21 configured in such a way with two flange elements 21.1, 21.2, the container wall of the bulk material container can be clamped in place (not illustrated) for example between these two flange elements 21.1, 21.2. This clamping preferably takes place such that the container wall is guided between the two flange elements 21.1, 21.2 before the two flange elements 21.1, 21.2 are mounted, and the two elements are then assembled. However, it is also possible to guide the container wall first for example from the top through the inner flange element and then from the bottom upward between the two flange elements 21.1, 21.2. There are in principle even more possible ways of fastening the container wall to or between the two flange elements, but most of them impede the flow of bulk material while the bulk material container is being emptied and therefore make less sense.

It should be noted that, in conjunction with the description of the figures, the terms bottom and top and also left and right relate to the respective illustration in the corresponding figure. They are not intended to mean that the corresponding elements always have to be arranged in this orientation.

Furthermore, a peripheral groove 35 is introduced in the inner side of the inner flange element 21.1. A peripheral tongue 36 on the outer periphery of the cylindrical portion 22.2 of the cone valve 22 engages in this groove 35 when, in order to close the opening in the connection flange 21, the cone valve 22 is fastened in the latter. In this way, the cone valve 22 is retained firmly in the connection flange 21 and undesired opening of the cone valve 22 is prevented.

Of course, the connection flange 21 can also consist of more than two flange elements, wherein the container wall or, in the case of a multilayer container wall, at least one, some or all of the layers can be clamped in place between two or more flange elements or otherwise fastened or attached to one or more of the flange elements in a known manner.

FIG. 3 shows in detail an embodiment in which the stripping elements according to the invention are located on the closure member 22. The lower edge of the lower end 22.3 of the cylindrical portion 22.2 of the cone valve 22 is configured as a peripheral edge 37.1 which is directed outward as seen from the cylindrical portion 22.2. In other words, it is directed in the direction of the inner surface 21.4 of the inner flange element 21.1. This edge 37.1 serves as a stripping element which, when the opening in the inner flange element 21.1 is closed, i.e. during the downward movement of the cone valve 22, frees the inwardly directed surface 21.4 of the inner flange element 21.1 of any adhering bulk material in that it strips the latter off downward. This inwardly directed surface region also includes in particular the groove 35. Furthermore, an edge 37.2 is located at the upper end of the inner side of the inner flange element 21.1, said edge 37.2, in a similar manner during the downward movement of the cone valve 22, freeing the outwardly directed surface 22.4 of the cylindrical portion 22.1 of the cone valve 22 of any adhering bulk material in that it strips the latter off as it were upward. Since, in this way, no or much less bulk material is located between the cone valve 22 and the connection flange 21, much better impermeability of the closure 3 of the bulk material container is achieved.

FIGS. 4 and 5 show a simple schematic illustration to better explain the inventive principle. What is illustrated is the lower cylindrical region 22.2 of a cone valve and the upper region of a connection flange 21. Arranged at the lower end of the cylindrical region 22.2 is a stripping element 34.1 which is configured in a triangular form in cross section in the simple case shown here. Specifically, this triangle is integrally formed on the cylindrical region 22.2 with its longest side, the shorter side is directed downward and the middle side upward. The tip of this triangle forms a peripheral edge 37.1. Similarly, a stripping element 34.2 is arranged at the upper end of the connection flange 21, wherein the whole is configured in a mirror-inverted manner. In other words, the stripping element 34.2 is in turn configured in a triangular manner, is integrally formed on the connection flange 21 with its longest side, the shorter side is directed upward and the middle side downward. The tip of this triangle forms a peripheral edge 37.2.

During the closing operation, the cone valve, i.e. the cylindrical region 22.2, is now moved in the direction of the arrow 24 and of the connection flange 21, wherein the latter remains in its position. FIG. 4 shows the two elements shortly before they come into contact. If the cylindrical region 22.2 is moved further in the direction of the arrow 24, the two short sides of the triangular stripping elements 34.1, 34.2 come into contact first. These are formed from an elastic material such that they deform and/or are compressed such that they slide past one another and the cylindrical region 22.2 can be moved further downward. As soon as the two edges 37.1, 37.2 have rubbed past one another, the two stripping elements 34.1, 34.2 return to their original shape. In this case, the edge 37.1 of the stripping element 34.1 first of all frees the downwardly directed long side of the stripping element 34.2 and then the inner surface 21.4, located therebeneath, of the connection flange 21 of bulk material or other contaminants. In a corresponding manner, the stripping element 34.2 first of all cleans the upwardly directed long side of the stripping element 34.1 and then the outer surface 22.4, located thereabove, of the cylindrical region 22.2. In other words, the two surface regions 21.4, 22.4 which are located opposite one another in the closed position are cleaned simultaneously during the closing operation. In order optionally to improve the cleaning further, the cone valve can be moved upward once more and then downward again with its cylindrical region 22.2, in order to repeat the stripping off of contaminants. This operation can be repeated as often as desired. In this case, it should be noted that, during the upward movement, the closure is not opened again to such an extent that bulk material can flow out of the bulk material container, recontaminating the already cleaned surfaces.

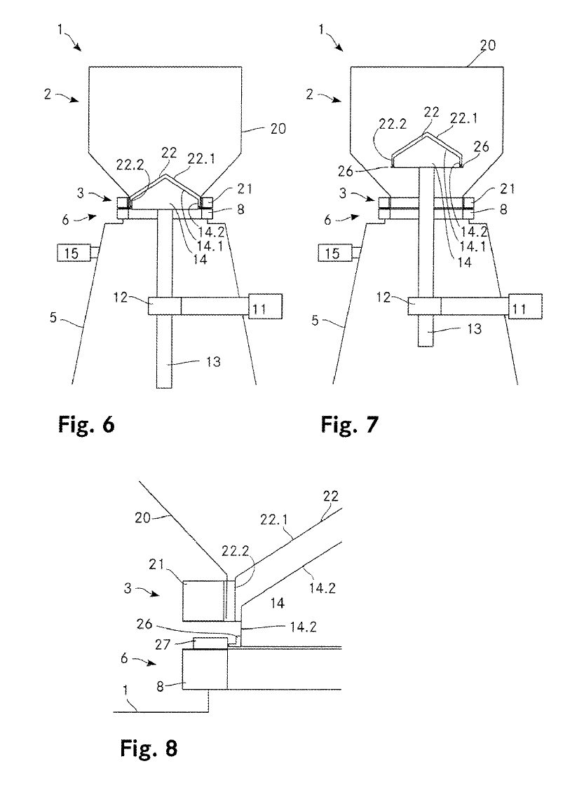

FIGS. 6 to 8 show a schematic illustration of a docking device 1 according to the invention having a connected bulk material container 2. In FIG. 6, the closure 3 of the bulk material container 2 is illustrated in the closed state, whereas in FIG. 7 it is illustrated in the open state. Finally, FIG. 8 shows an enlarged detail of the sealing according to the invention of the docking device 1.

The docking device 1 comprises a housing 5 and a connection part 6 which comprises a connection flange 8. Arranged within the housing 5 is a closure actuating device which comprises a motor 11, a transmission unit 9, an angular gear 12, a drive spindle 13 and a lifting cone 14 as closure actuating element. The lifting cone 14 is fastened to the upper end of the drive spindle 13. It comprises a conical portion 14.1 and a cylindrical portion 14.2 adjoining the latter at the bottom.

The motor 11 is arranged horizontally and outside the housing 5. The transmission unit 9 couples the motor 11 to the angular gear 12, which is configured for example as a worm gear. The motor 11 generates a rotary movement about a horizontal axis, wherein this rotary movement is transmitted by the transmission unit 9 to the worm gear and is converted by the latter into an axial movement of the drive spindle 13—in this case in the vertical direction. In this way, the lifting cone 14 can be moved up or down in a vertical direction of movement. However, the motor can also be arranged vertically, wherein the transmission unit then transmits the rotary movement in a linear manner to the drive spindle.

The bulk material container 2 comprises a container wall 20 and also a connection flange 21 and a cone valve 22. Both the connection flange 21, the cone valve 22 and the connection flange 8 of the connection part 6 are configured in a rotationally symmetrical manner, wherein FIGS. 6-8 show a schematic section through these devices. The container wall 20 of the bulk material container 2 is fastened to the connection flange 21. In the present example, the container wall is adhesively bonded, welded, firmly clamped or fastened in some other way to the inner side of the connection flange 21. The container wall 20 can also be fastened to the end side of the connection flange 21. The cone valve 22 comprises a conical portion 22.1 and a cylindrical portion 22.2 adjoining the latter at the bottom.

The shapes of the lifting cone 14 and the cone valve 22 are in this case coordinated with one another such that the lifting cone 14 can be moved into the cone valve 22 from below so as to fit therein and the cone valve 22 can be accordingly lifted by the lifting cone 14.

In FIGS. 6 and 7, the bulk material container 2 is coupled to the closure flange 8 of the closure part 6 with its closure flange 21. In FIG. 6, the cone valve 22 is furthermore shown in its closed position, in which it is arranged within the closure flange 21 and completely closes the internal opening therein with its cylindrical portion 22.2. In this example, in which the container wall 20 is fastened to the inner side of the closure flange 21, the container wall 20 is located between the cone valve 22 and the connection flange 21 in the closed position of the cone valve 22. In other words, the cone valve 22 is in direct contact with the container wall 20 and thus closes the bulk material container 2.

In FIG. 7, the closure 3 of the bulk material container 2 is illustrated in the open state. In other words, the drive spindle 13 has been lifted with the lifting cone fastened to its upper end. As a result, the cone valve 22 has also been lifted, with the result, since the connection flange 21 of the bulk material container is coupled to the connection flange 8 of the connection part 6, that the opening in the connection flange 21 of the bulk material container 2 has been freed up and so the bulk material can flow out of the interior of the bulk material container 2 through the housing 1. It is clear to see here that, as it is being lifted by the upwardly moved drive spindle 13, the lifting cone 14 pushes the cone valve 22 out of the connection valve 21 of the bulk material container 2 and lifts it along with itself.

The seal 26 according to the invention between the lifting cone 14 and connection flange 8 of the connection part 6 is not clear to see in FIGS. 6 and 7 and therefore has been illustrated in an enlarged manner in FIG. 8. This seal 26 is attached to the outer periphery of the cylindrical portion 14.2 of the lifting cone 14 and accordingly extends radially outward. A seal element 27 attached to the upper side of the connection flange 8 of the connection part 6 can also be seen in FIG. 8, the outer periphery of the seal 26, i.e. the end side thereof, cooperating with said seal element 27 in a sealing manner. In this way, in the closed position of the lifting cone 14, the particular radial stress with a corresponding sealing action is achieved between the lifting cone 14 and the connection flange 8 of the connection part 6.

Furthermore, the docking device 1 comprises a vibration unit 15 which is fastened to the housing 5. This vibration unit 15 creates vibrations which are transmitted via the housing 5 to the connection part 6 and accordingly to the connection flange 21 or the container wall 20 of a bulk material container 2 connected to the connection part 6. In this way, the bulk material container is set in vibration, this serving to fluidize the bulk material and thus supporting the emptying or filling operation.

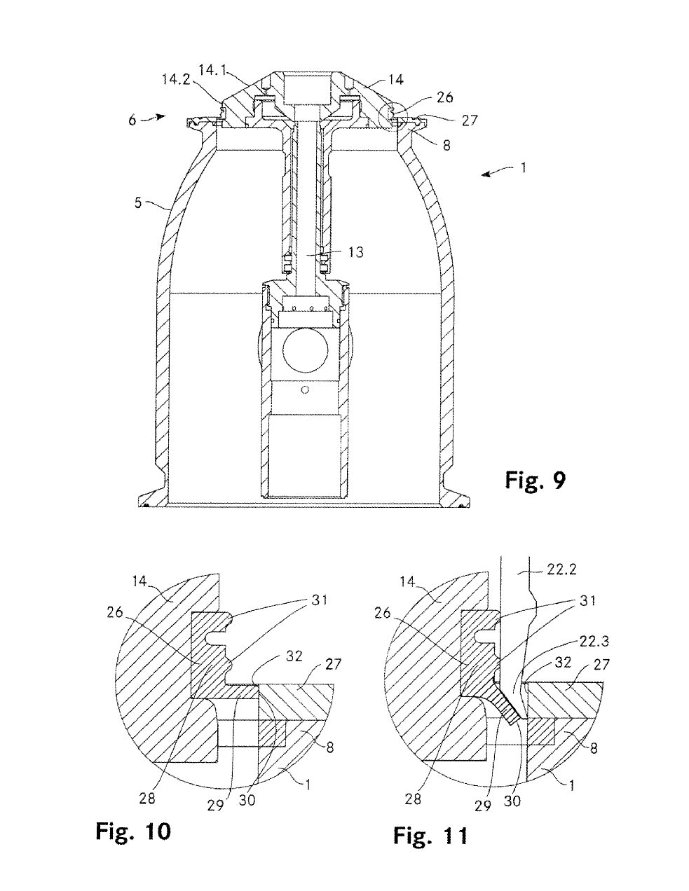

FIG. 9 shows a schematic illustration of a further docking device 1 according to the invention without a coupled bulk material container. The housing 5 is configured in the form of a hood with a downwardly directed opening in this example. The connection part 6 having the connection flange 8 is in turn formed in the upper region of the housing 5.

The lifting cone 14 in turn substantially comprises a conical portion 14.1 and a cylindrical portion 14.2, wherein the conical portion 14.1 comprises a flattened tip and the cylindrical portion 14.2, rather than having a smooth surface, has a structured surface. Specifically, the cylindrical portion 14.2 comprises a recess for receiving the seal 26. The seal 26 can be configured both in one piece and in several pieces, i.e. consist of several annular parts which are placed concentrically against and/or in one another.

For better understanding, an enlarged illustration of the region of the docking device 1 having the seal 26 is shown in FIG. 10. The seal 26 comprises a base 28 on which several different portions are integrally formed. Integrally formed on the base 28 at the lower end is a first, substantially rectangular portion 29. This portion 29 provides the radial seal between the lifting cone 14 and the connection flange 8 of the housing 1 or the additional seal element 27 which is arranged on the connection flange 8 of the housing 1. To this end, it has an end region 30 which is located at the outer periphery of the portion 29 and thus at the outer periphery of the seal 26. This end region 30 is illustrated as being flat and parallel to the direction of movement of the drive spindle 13 and thus of the lifting cone 14. However, this does not absolutely have to be the case. The end region 30 can also have a non-flat surface and be at an angle to the direction of movement of the drive spindle 13. This radial end region 30 is located opposite an active region 32 of the seal element 27 in the closed position of the lifting cone 14, said active region 32 likewise being located parallel to the direction of movement of the lifting cone 14. The length of the portion 29 or of the entire seal 26, i.e. the length thereof in the radial direction, is in this case advantageously selected, in order to achieve the best possible sealing action, such that it is minimally longer than the distance from the sealing element 27. In the closed position of the lifting cone 14, the portion 29 is therefore very slightly compressed (not illustrated), with the result that the radial stress for the desired sealing action is achieved.

The seal 26 or the sealing element 29 is in this case configured and arranged such that, as a result of an axial displacement of the seal 26 at the end of the closing operation, the seal 26 is pressed radially against the seal element 27, resulting in the radial stress and the enhanced sealing action. During the closing operation of the closure actuating element, the latter is moved for example downward. The seal portion 29, the diameter of which is of course larger than the inside diameter of the connection flange 8, is consequently present at the upper edge of the connection flange 8 and is so to speak pushed away upward during the further downward movement. Subsequently, the closure actuating element is moved slightly upward again, wherein the free end of the seal portion 29 catches on an edge on the inner side of the connection flange and therefore cannot move further upward. Since, in this way, the free end of the seal portion 29 is retained, it is transferred into the horizontal and simultaneously compressed by the further movement of the closure actuating element, with the result that the particular sealing action is achieved. This can of course also take place in the other direction of movement. If the peripheral free end of the seal portion 29 is for example pushed away downward beforehand, the seal portion 29 can catch on a corresponding edge on the inner side of the connection flange by a further downward movement and is then correspondingly pressed into the horizontal from above. This is the case for example when a closure has been coupled beforehand, the cone valve of which has pushed the seal portion 29 downward.

Furthermore, two lips 31 are integrally formed on the base 28, said lips serving to provide sealing between the lifting cone 14 and the cone valve 22 of a closure coupled to the connection flange 8. This is illustrated in FIG. 11. The lifting cone 14 is likewise located still in its closed position but, in contrast to FIG. 10, FIG. 11 additionally shows the cylindrical portion 22.2 of the cone valve 22 of a coupled closure. Among other things, the cone valve 22 is held against the lifting cone by the seal 26 when said lifting cone is adjusted. For this purpose, it is also possible to provide further active or passive retaining or clamping means, however.

The specific configuration and arrangement of the seal 26 or of the portion 29 are in this case selected such that the lower end 22.3 of the cylindrical portion 22.2 of a closure coupled to the connection flange 8 pushes the portion 29 away downward. This can likewise be readily seen in FIG. 11. Specifically, if a closure is coupled, it is no longer necessary to provide sealing between the lifting cone 14 and the connection flange 8, in particular for emptying the bulk material container, i.e. when the lifting cone 14 is in an open position. It is even the case that the portion 29 would impede the emptying of the bulk material if it were not pushed away downward but rather, as illustrated in FIG. 10, protruded radially from the lifting cone. It would then project into the flow area of the bulk material, this being undesired.

However, the seal element 27 serves not only to provide sealing between the lifting cone 14 and the connection flange 8 without a coupled closure, but also to provide sealing between the connection flange 8 and a closure, coupled thereto, of a bulk material container. To this end, the seal element 27 comprises for example a thickened portion which is located in a corresponding groove in the connection flange 8 and acts in the same way as or in a similar way to a sealing ring introduced separately into this groove. The seal element 27 can also have further structuring for improving the sealing between the connection flange 8 and a closure coupled thereto.

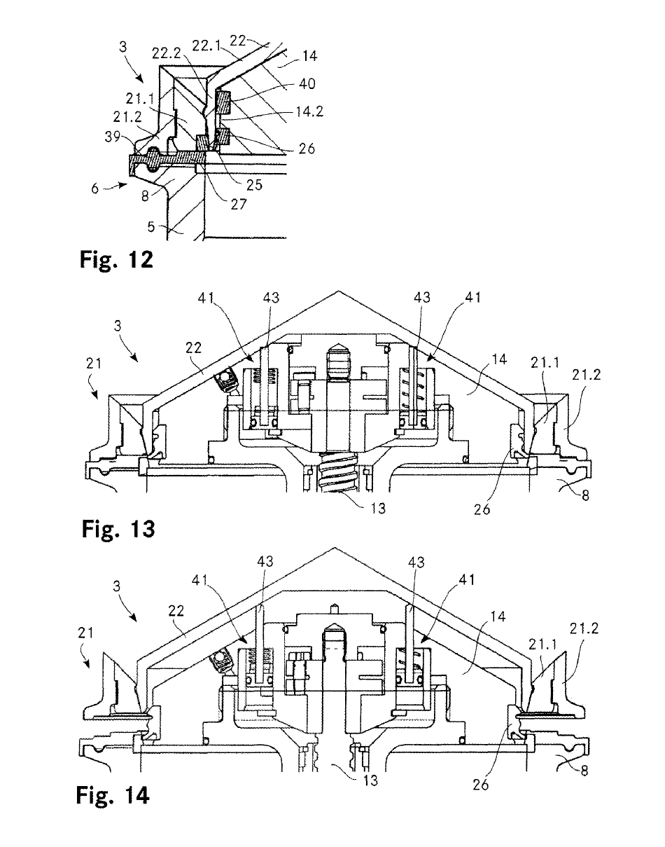

FIG. 12 shows an enlarged illustration of the connection part of the docking device 1 from FIG. 9 with the closure 3 from FIG. 1 connected thereto. In addition to the elements already illustrated before, FIG. 12 also shows three further aspects. Firstly, the seal element 27 comprises a thickened portion 39 which extends upward and downward and extends in corresponding grooves in the connection flange 8 and the outer flange element 21.2 and in this way improves the sealing between the connection flange 8 and the outer flange element 21.2 in the coupled state. Secondly, FIG. 12 shows a retaining device 40 which is arranged on the outer periphery of the cylindrical portion 14.2 of the lifting cone 14, for example has been introduced into a corresponding groove. This retaining device serves to retain the valve cone 22 on the lifting cone 14 during the opening and closing of the closure 3. And thirdly, a further seal element 25 is illustrated, which serves to provide sealing between the connection flange 21 of the closure 3 and the cone valve 22 in its closed position, as is shown in FIG. 12. This seal element 25 is advantageous in particular when gaseous or liquid bulk material is intended to be processed. In addition, this seal element 25 is produced from an elastically deformable material, such as an elastomer for example. In the case of a two-part connection flange 21, as is the case in the present example, the seal element 25 is consequently arranged on the inner side of the inner flange element 21.1. Preferably, it is arranged at the lower end of the flange element 21.1. However, it can also be attached to the outwardly directed surface 22.4 of the cylindrical portion 22.1. In the first-mentioned position, this seal element 25 can not only provide sealing between the connection flange 21 and the cone valve 22, but also between the connection flange 21 of the closure 3 and the connection flange 8 of the docking device, when the closure 3 has been coupled to the connection part 6.

FIGS. 13 and 14 show a schematic illustration of a further closure 3 according to the invention. In this example, the closure 3 comprises an uncoupling device 41. FIG. 13 shows the closure 3 coupled to a docking device and FIG. 14 shows it in the state uncoupled therefrom.

The connection flange 8 of a docking device is illustrated, as is the lifting cone 14 in its closed position in which it closes the through-opening in the connection flange 8. Fastened to the underside of the lifting cone 14 is the drive spindle 13, with which the lifting cone 14 is movable in the axial direction of the drive spindle 13. Also illustrated is the closure 3, which comprises a connection flange 21 made of two flange elements 21.1, 21.2, and also the cone valve 22, which is likewise illustrated in its closed position, i.e. completely closes the interior of the inner flange element 21.1.

The uncoupling device 41 is a mechanism which is arranged entirely in the interior or on the inner side of the lifting cone 14. It comprises one or more plungers 43 which are movable relative to the lifting cone 14 in the same direction of movement as the lifting cone 14, i.e. in the direction of the drive spindle 13 and thus perpendicularly to the through-opening in the connection flange 8. The plungers 43 are guided for example in the housing of the lifting cone 14 such that they can move exclusively in the direction of movement. They are also arranged such that they are normally located in a passive position in which they have been moved inward (downward according to the illustration) and are located entirely in the lifting cone 14. When they are moved outward (upward according to the illustration), the plungers 43 pass with their upper end out of the lifting cone 14 and in this way push the cone valve 22 together with the entire closure 3 away from the lifting cone 14 and thus also from the connection flange 8 or the entire docking device. In other words, the docking device and closure 3 are uncoupled from one another in this way.

FIG. 13 shows the plungers 43 in their passive position in which they have been retracted. The cone valve 22 rests directly on the lifting cone 14. In FIG. 14, the plungers 43 have, by contrast, been extended and the cone valve 22 has been lifted from the lifting cone 14.

The plungers 43 are moved by a drive which is configured in a pneumatic, hydraulic, electric or some other suitable way. A pneumatic drive is appropriate, since a pneumatic gas device is often already present in such docking devices.

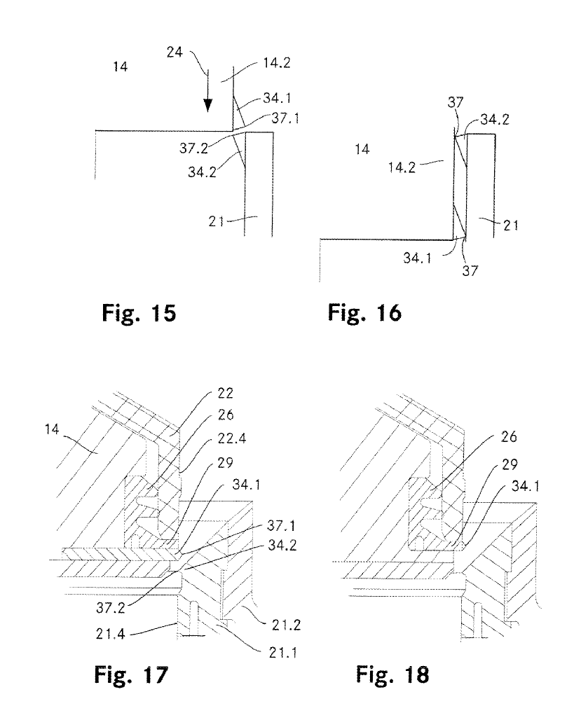

FIGS. 15 and 16 show a simple schematic illustration of a variant embodiment in which the stripping element 34.1 is arranged on the cylindrical region 14.2 of the lifting cone 14. A stripping element 34.2 is in turn arranged at the upper end of the connection flange 21. The manner in which the stripping elements 34.1, 34.2 with the respective edges 37.1 and 37.2 function is the same as in the variant embodiment in which the stripping element 34.1 is arranged on the cone valve, illustrated in FIGS. 4 and 5.

FIG. 17 shows a detail view of an embodiment as is illustrated in FIGS. 15 and 16. The stripping element 34.1 is located on the lifting cone 14 directly beneath the seal 26 having the seal portion 29 directed radially outward. The stripping element 34.1 has a triangular shape in the front region directed toward the inner side 21.4 of the connection flange 21.1. The tip of this triangle forms a peripheral edge 37.1. In contrast to the above-described embodiment, this triangle has two equally long sides. Arranged at the upper end of the connection flange 21.1 is a second stripping element 34.2, in turn having a peripheral edge 37.2.

The function of the stripping element 34.1 is the same as in the variant embodiment in which the stripping element 34.1 is arranged on the cone valve 22, as illustrated in FIG. 3. When the lifting cone 14 is moved downward, the stripping element 34.1 frees the inwardly directed surface 21.4 of the inner flange element 21.1 of any adhering bulk material in that it strips the latter off downward. The stripping element 37.2 frees the outwardly directed surface 22.4 of the cone valve 22 of any adhering bulk material in that it strips the latter off from bottom to top.

FIG. 18 shows a further variant embodiment in which the stripping element 34.1 is integrated in the seal 26, or is part thereof. This means that the front part of the seal portion 29 of the seal 26 assumes the stripping function. The front part is preferably produced from a more rigid material than the rest of the seal 26. For example, the front part consists of a hard plastics material and has been cast in the elastic steel material of the seal 26. It is not absolutely necessary for the seal portion 29 to assume the stripping function. The stripping element can also be arranged in some other part of the seal 26.

It is possible, in a further variant embodiment, for no stripping element to have been attached to the flange element 21.1, and thus for only the stripping element 34.1 attached to the lifting cone 14 to be present.

In summary, it can be stated that the invention makes it possible to further improve a closure for a bulk material container and also a device for emptying or filling bulk material, in that the impermeability thereof is improved. This being the case both when no bulk material container has been connected to the device and when this is the case. Improved impermeability is in particular important in the case of increased demands made of hygiene or cleanliness, as is the case for instance in toxic or food-containing bulk material or in the case of pharmaceuticals or when particular circumstances apply for some other reason.

1. A closure arrangement, comprising a closure for a bulk material container, which comprises an annular connection flange having a through-opening and a first movable element, namely a closure member for selectively closing or opening the through-opening, wherein a container wall of the bulk material container is able to be fastened to the connection flange, wherein the closure arrangement also comprises a docking device having a housing and a second movable element, namely a closure actuating device, characterized in that one of the movable elements comprises a peripheral, first stripping element such that contaminants are able to be stripped from a surface of the connection flange during a closing operation for closing the through-opening in the connection flange.

2. The closure arrangement as claimed in claim 1, wherein a peripheral, second stripping element is arranged on the connection flange in the region of the through-opening, contaminants being able to be stripped from a surface of the closure member by said second stripping element during a closing operation for closing the through-opening with the closure member, wherein the first and/or the second stripping element is/are configured in particular as a retaining or clamping device for retaining in its closed position in the closure flange.

3. The closure arrangement as claimed in claim 1, wherein the closure member comprises a conical portion and a cylindrical portion adjoining the latter, wherein the first stripping element is arranged in an end region of the cylindrical portion that is remote from the conical portion.

4. The closure arrangement as claimed in claim 1, wherein the closure actuating device comprises an adjusting device and a closure actuating element and the first stripping element is arranged on a cylindrical portion of the closure actuating element.

5. The closure arrangement as claimed in claim 1, wherein the second stripping element is arranged on the connection flange such that, in a closed position of the closure member in which the latter closes the through-opening, it is located opposite a region of the cylindrical portion which is located closer to the conical portion of the closure member than the first stripping element.

6. The closure arrangement as claimed in claim 1, wherein, in order to provide sealing between the connection flange and the closure member in a closed position of the closure member in which the latter closes the through-opening, the closure comprises an annular closure seal made of elastically deformable material, said closure seal being arranged in particular in an inner region of the annular connection flange.

7. The closure arrangement as claimed in claim 1, wherein at least the closure member or the connection flange, preferably both, consist at least partially of a material that is not elastically deformable, for example a polymer such as polypropylene or polyethylene, for instance.

8. The closure arrangement as claimed in claim 1, wherein at least one, preferably both stripping elements consist of an elastically deformable material.

9. The closure arrangement as claimed in claim 1, wherein the first stripping element is configured as a seal in order to provide sealing between the housing and the closure actuating element.

10. The closure arrangement as claimed in claim 9, wherein the seal is under radial compressive stress in the closed position and without a closure of a bulk material container being connected to a connection part, such that the seal is pressed against an active region of the connection part.

11. A method for closing a closure for a closure arrangement as claimed in claim 1, wherein the closure member is moved in a direction of movement perpendicular to the through-opening from an open position, leaving the through-opening open, into a closed position, closing the through-opening, of the closure member, wherein contaminants are stripped from an inner surface of the connection flange by a first stripping element arranged on one of the movable elements, and contaminants are in particular also stripped from an outer surface of the closure member by the second stripping element arranged on an inner side of the connection flange.

12. The method as claimed in claim 11, wherein, after the connection flange has been closed, the movable elements having the stripping element are moved in the direction of the open position again and then back into the closed position, and so further contaminants are stripped from a surface of the connection flange and in particular also from an outer surface of the closure member, wherein this operation is repeated in particular two or more times.

13. A bulk material container having a closure as claimed in claim 1, wherein the bulk material container also comprises a container wall, characterized in that the container wall is fastened to the connection flange of the closure.

14. A docking device for docking a closure of a bulk material container and for emptying bulk material from the bulk material container and filling the bulk material container with bulk material, comprising a housing, a connection part for connecting the closure, a closure actuating device for actuating the closure, wherein the closure actuating device comprises a closure actuating element and an adjusting device and the closure actuating element is movable selectively between a closed position and an open position in a direction of movement with the adjusting device, wherein the docking device comprises a seal which serves to provide sealing between the housing and the closure actuating element, characterized in that the seal is under radial compressive stress in the closed position and without a closure of a bulk material container being connected to the connection part, such that the seal is pressed against an active region of the connection part.

15. The docking device as claimed in claim 14, wherein the seal is configured in an annular manner and is arranged around an outer periphery of the closure actuating element.

16. The docking device as claimed in claim 14, wherein the seal comprises a seal portion having an active region, wherein the active region of the seal portion is pressed onto an active region of the connection part.

17. The docking device as claimed in claim 16, wherein the seal has a base in the form of a circular ring and the seal portion is configured in the form of a circular ring and is integrally formed on the base, and extends radially outward with regard to the direction of movement, wherein an outside diameter of the seal portion in the form of a circular ring is greater than an inside diameter of a surface portion on an inner side of the connection part, said surface portion being located opposite the seal portion in a closed position of the closure actuating element and cooperating therewith in a sealing manner.

18. The docking device as claimed in claim 17, wherein the surface portion on the inner side of the connection part is formed by a sealing element made of an elastically deformable material, wherein the sealing element comprises the active region.

19. The docking device as claimed in claim 14, wherein the active region is oriented parallel to the direction of movement.

20. The docking device as claimed in claim 14, wherein the seal comprises a stripping element such that, during a closing operation for closing the through-opening in the connection flange with the closure actuating element, contaminants are able to be stripped from a surface of the connection flange.

21. The docking device as claimed in claim 14, which comprises at least one vibration unit with which it is able to be set in vibration in order to support an emptying operation and/or a filling operation of a bulk material container connected to the docking device, wherein the vibration unit is fastened or able to be fastened in particular to the outside of the housing.

22. A method for closing a docking device as claimed in claim 14, characterized in that the closure actuating element is moved in a first step from the open position in a closing direction in the direction of the closed position and beyond the closed position, and in a second step, it is moved counter to the closing direction into the closed position.

23. The method for closing a docking device as claimed in claim 22, wherein the closure actuating element is moved beyond the closed position by a distance D, wherein the distance D corresponds to at least one time and at most three times an extension in the direction of movement of a contact region between the seal and the connection part in the closed position.

24. The method for closing a docking device as claimed in claim 22, wherein the closing direction from the open position to the closed position is directed vertically from top to bottom.
